(19) United States
(12) Patent Application Publication
(10) Pub. No.: US 2025/0151069 A1
(43) Pub. Date: May 8, 2025

(54) EXPANDED SKIPPING OF PDCCH MONITORING

(71) Applicant: Lenovo (Singapore) Pte. Limited, Singapore (SG)

(72) Inventors: Hossein Bagheri, Urbana, IL (US); Hyejung Jung, Northbrook, IL (US); Razvan-Andrei Stoica, Essen (DE); Vijay Nangia, Woodridge, IL (US)

(73) Assignee: Lenovo (Singapore) Pte. Limited, Singapore (SG)

(21) Appl. No.: 18/837,114

(22) PCT Filed: Feb. 8, 2023
(86) PCT No.: PCT/IB2023/051092

§ 371 Date: Aug. 8, 2024

Related U.S. Application Data
(60) Provisional application No. 63/308,312, filed on Feb. 9, 2022.

(51) Int. Cl. H04W 72/23; H04L 43/087

(52) U.S. Cl. CPC H04W 72/23; H04L 43/087

(57) ABSTRACT

Various aspects of the present disclosure relate to a user equipment (UE) that maintains a set of skipping durations that includes multiple subsets of skipping durations. The base station transmits to the UE a first control signaling indicating to activate one of the subsets of skipping durations. At a subsequent time, the base station transmits to the UE a second control signaling indicating that the UE can skip physical downlink control channel (PDCCH) monitoring in some time resources (e.g., slots). The second control signaling includes an identifier of a skipping duration and the UE selects the identified skipping duration in the active subset of skipping duration values. The UE then skips or terminates monitoring of the PDCCH for the selected skipping duration.

### RELATED APPLICATION

This application claims priority to U.S. Patent Application Ser. No. 63/308,312 filed Feb. 9, 2022 entitled “Expanded Skipping of PDCCH Monitoring,” the disclosure of which is incorporated by reference herein in its entirety.

### TECHNICAL FIELD

The present disclosure relates to wireless communications, and more specifically to expanded skipping of physical downlink control channel (PDCCH) monitoring.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, component carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

A wireless communication system may allow the base station to transmit control information to the UE, such as via a PDCCH. The UE monitors various time resources (e.g., slots or PDCCH monitoring occasions) to receive the control information, such as downlink control information (DCI), on the PDCCH. There are numerous possible time resources during which the base station may transmit control information to the UE on the PDCCH, although oftentimes the base station does not transmit control information to the UE during every possible time resource.

### SUMMARY

The present disclosure relates to methods, apparatuses, and systems that support expanded skipping of PDCCH monitoring. The UE maintains a set of skipping durations that includes multiple subsets of skipping durations (e.g., 3 skipping durations per subset). The base station transmits to the UE, such as in a medium access control-control element (MAC-CE), an indication to activate one of the subsets of skipping durations. At a subsequent time or at the same time, the base station transmits an indication to the UE, such as in the DCI, that the UE can skip PDCCH monitoring (e.g., according to Type3-PDCCH Common Search Space (CSS) sets or UE-specific (USS) sets on a serving cell) in some time resources (e.g., slots or PDCCH monitoring occasions). The indication includes an identifier of a skipping duration and the UE selects the identified skipping duration in the active subset of skipping duration values. The UE then skips monitoring of the PDCCH for the selected skipping duration. By utilizing the described techniques, a network device (e.g., a UE) is able to reduce power consumption by skipping PDCCH monitoring for the selected skipping duration.

Some implementations of the method and apparatuses described herein may include wireless communication at a device (e.g., at a UE), which includes receiving, from a base station, first control signaling indicating a set of durations associated with skipping monitoring for a PDCCH; receiving, from the base station, second control signaling indicating to activate a first subset of durations of the set of durations; receiving, from the base station, third control signaling indicating for the UE to skip, terminate, or pause monitoring a set of PDCCH candidates (e.g., associated with the PDCCH), according to a set of DCI formats for a serving cell, during a first time duration associated with or selected from the first subset of durations; and skip, terminate, or pause monitoring the set of PDCCH candidates (e.g., associated with the PDCCH) during the first time duration associated with or selected from the first subset of durations based at least in part on the received third control signaling.

In some implementations of the method and apparatuses described herein, the first control signaling is a Radio Resource Control (RRC) indication, the second control signaling is a MAC-CE indication. Additionally or alternatively, the third control signaling is a PDCCH such as a PDCCH according to a DCI format (such as DCI format 0_1, and/or DCI format 1_1, and/or DCI format 0_2, and/or DCI format 1_2) that schedules a PUSCH transmission or a PDSCH reception which can include a PDCCH monitoring adaptation field. Additionally or alternatively, the MAC-CE is scheduled via the PDCCH (referred to as first PDCCH) or via another PDCCH (referred to as second PDCCH) for instance, when the first PDCCH schedules Uplink (UL) transmission. In an example, the second PDCCH can be sent by the network earlier (such as at least a certain or pre-determined time earlier) than the first PDCCH. Additionally or alternatively, the method and apparatuses may include determining whether the first subset of durations is valid for the third control signaling; and in response to determining the first subset of durations is valid, terminate monitoring the set of PDCCH candidates during the first time duration. Additionally or alternatively, the method and apparatuses may include determining a default subset of durations of the set of durations; and in response to determining the first subset of durations is not valid for the third control signaling, terminate monitoring the set of PDCCH candidates associated with the PDCCH during a second time duration associated with the default subset of durations based at least in part on the received third control signaling. Additionally or alternatively, the UE is not configured with a set of skipping durations from which a first subset of durations can be activated (by the network), and can be configured with a default set of PDCCH skipping durations; and in response to determining the UE is not configured with a set of skipping durations from which a first subset of durations can be activated (by the network), terminate monitoring the set of PDCCH candidates associated with the PDCCH during a second time duration associated with the default subset of durations based at least in part on the received third control signaling. Additionally or alternatively, the method and apparatuses may include determining to terminate monitoring the set of PDCCH candidates associated with the PDCCH during the first time duration associated with the first subset of durations based at least in part on the received third control signaling, and traffic jitter statistics or a set of traffic jitter values, wherein traffic jitter is a difference between an actual traffic arrival time and an expected nominal traffic arrival time (such as according to a traffic periodicity e.g., video frame-per second rate such as 60 frame per seconds). Additionally or alternatively, the method and apparatuses may include receiving a configuration for a first search space set within the set of PDCCH candidates; receiving a MAC-CE indicating to not skip the first search space set upon reception of the third control signaling, the MAC-CE further including a search space set identifier (ID) corresponding to the first search space set; and excluding a time associated with the first search space set from the first time duration. Additionally or alternatively, the second control signaling is a MAC-CE, and wherein determining whether the first subset of durations is valid for the third control signaling includes determining that the first subset of durations is valid if a positive acknowledgment is generated in response to the MAC-CE and the positive acknowledgment is not sent to the base station earlier than a threshold time from a reference time (e.g., the time when the third control signaling is received). Additionally or alternatively, the method and apparatuses may include receiving, from the base station, a fourth control signaling; and determining the traffic jitter statistics or the set of traffic jitter values based at least in part on the received fourth control signaling.

Some implementations of the method and apparatuses described herein may include wireless communication at a device (e.g., at a base station), which includes transmitting, to a UE, first control signaling indicating a set of skipping durations associated with skipping of monitoring for a PDCCH; transmitting, to the UE, second control signaling indicating to activate a first subset of durations of the set of durations; transmitting, to the UE, third control signaling indicating for the UE to terminate monitoring a set of PDCCH candidates (e.g., associated with the PDCCH), according to a set of DCI formats for a serving cell, during a first time duration associated with the first subset of durations; and terminate transmitting DCI messages to the UE during the first time duration associated with the first subset of durations.

In some implementations of the method and apparatuses described herein, the second control signaling is a MAC-CE. Additionally or alternatively, the MAC-CE is scheduled via the PDCCH. Additionally or alternatively, the method and apparatuses may include transmitting, to the UE, a fourth control signaling indicating a configuration for a first search space set within the set of PDCCH candidates; transmitting, to the UE, a MAC-CE indicating to not skip the first search space set upon reception of the third control signaling, the MAC-CE further including a search space set ID corresponding to the first search space set; and excluding a time associated with the first search space set from the first time duration.

### BRIEF DESCRIPTION OF THE DRAWINGS

Various aspects of the present disclosure for expanded skipping of PDCCH monitoring are described with reference to the following Figures. The same numbers may be used throughout to reference like features and components shown in the Figures.

FIG. 1 illustrates an example of a wireless communications system that supports expanded skipping of PDCCH monitoring in accordance with aspects of the present disclosure.

FIG. 2 illustrates an example PDCCH skipping duration set in accordance with aspects of the present disclosure.

FIG. 3 illustrates an example of potential ranges for PDCCH skipping.

FIG. 4 illustrates an example of extended reality (XR) traffic.

FIG. 5 illustrates an example of determining the PDCCH skipping value based at least in part on jitter.

FIG. 6 illustrates an example of monitoring PDCCH after a transmission.

FIG. 7 illustrates an example of a block diagram of a device (e.g. a UE) that supports expanded skipping of PDCCH monitoring in accordance with aspects of the present disclosure.

FIG. 8 illustrates an example of a block diagram of a device (e.g., a base station) that supports expanded skipping of PDCCH monitoring in accordance with aspects of the present disclosure.

FIGS. 9-13 illustrates a flowchart of methods that support expanded skipping of PDCCH monitoring in accordance with aspects of the present disclosure.

### DETAILED DESCRIPTION

Implementations of expanded skipping of PDCCH monitoring are described, such as related to methods, apparatuses, and systems that support expanded skipping of PDCCH monitoring. Aspects of the disclosure include the UE maintaining a set of skipping durations that includes multiple subsets of skipping durations (e.g., 3 skipping durations per subset). Each of these skipping durations is a value indicating an amount of time resources (e.g., slots) that the UE can skip monitoring. These values may take various forms, such as an amount of time (e.g., a number of milliseconds (ms)), a number of PDCCH candidate time resources (e.g., a number of slots or other time resources during which a PDCCH may be sent), a number of time units (e.g., slots) associated with a reference subcarrier spacing, and so forth.

The base station transmits to the UE, such as in a MAC-CE, an indication to activate one of the subsets of skipping durations. At a subsequent time or at the same time, the base station transmits an indication to the UE (e.g., a skipping indication), such as in the DCI, that the UE can skip PDCCH monitoring in some time resources (e.g., slots). The skipping indication includes an identifier of a skipping duration and the UE selects the identified skipping duration in the active subset of skipping duration values. The UE then skips monitoring of the PDCCH for the selected skipping duration.

By utilizing the described techniques, a network device (e.g., a UE) is able to reduce power consumption by skipping PDCCH monitoring during time resources (e.g., slots) where the base station does not expect to schedule a UL, downlink (DL), or sidelink (SL) transmission. Furthermore, the described techniques allow the skipping indication in the DCI to remain small (e.g., two bits) while at the same time allowing many more skipping durations to be identified than would typically be available with a small DCI. For example, two bits would typically allow only four different skipping durations to be identified, whereas the techniques discussed herein allow hundreds, thousands, or more skipping durations to be identified still via a two-bit indication in DCI with the help of MAC-CE indication of active subset of skipping durations.

Aspects of the present disclosure are described in the context of a wireless communications system. Aspects of the present disclosure are further illustrated and described with reference to device diagrams and flowcharts that relate to expanded skipping of PDCCH monitoring.

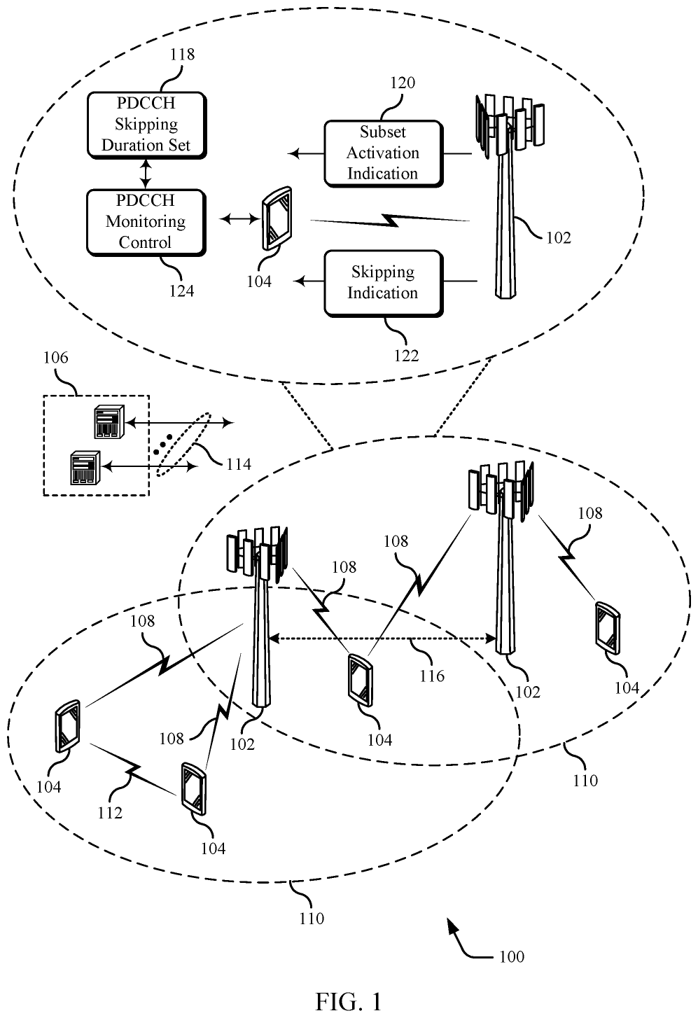

FIG. 1 illustrates an example of a wireless communications system 100 that supports expanded skipping of PDCCH monitoring in accordance with aspects of the present disclosure. The wireless communications system 100 may include one or more base stations 102, one or more UEs 104, a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a new radio (NR) network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a SL. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 116 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as a radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of expanded skipping of PDCCH monitoring, as described herein. In one or more implementations, a UE 104 maintains a set of PDCCH skipping durations 118 that includes multiple subsets of PDCCH skipping durations. The PDCCH skipping duration set 118 may be received from a base station 102 or other device (e.g., via a first control signaling). A base station 102 transmits a subset activation indication 120 to the UE 104 (e.g., via a second control signaling), which is an indication to activate one of the subsets of PDCCH skipping durations in the PDCCH skipping duration set 118. The base station 102 subsequently or at the same time transmits a skipping indication 122 to the UE 104 (e.g., via a third control signaling), which is an indication for the UE 104 to skip, terminate, pause, or stop monitoring a set of PDCCH candidates from the base station 102 for a time duration. The terms “skip,” “terminate,” “pause,” and “stop” may be used interchangeably throughout the present disclosure. The skipping indication 122 is transmitted, for example, as part of a DCI in a PDCCH. The UE 104 performs PDCCH monitoring control 124 to terminate monitoring the set of PDCCH candidates for a time duration that is based at least in part on the skipping indication and the activated subset of PDCCH skipping durations. For example, during the time duration the UE 104 does not monitor PDCCH candidates associated with the PDCCH, which are be any slots in which a DCI may be sent in a PDCCH.

Similarly, the base station 102 terminates or stops transmitting DCI messages (e.g., according to Type3-PDCCH CSS sets or USS sets on a serving cell) to the UE 104 for the time duration that is based at least in part on the skipping indication and the activated subset of PDCCH skipping durations. During the time duration the base station 102 does not transmit DCI messages during PDCCH candidates associated with the PDCCH (e.g., any slots in which the base station 102 otherwise may transmit a DCI sent in the PDCCH). For example, the base station 102 has the same set of PDCCH skipping durations as the UE 104 and can determine the same time duration as the UE 104 determines.

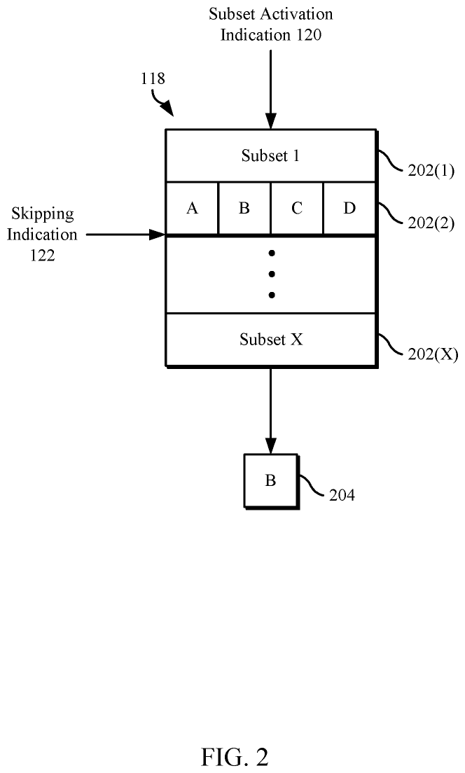

FIG. 2 illustrates an example PDCCH skipping duration set 118 in accordance with aspects of the present disclosure. The PDCCH skipping duration set 118 includes multiple (X) PDCCH skipping duration subsets 202(1), 202(2), . . . , 202(X). A subset activation indication 120 is received that identifies one of the subsets in the PDCCH skipping duration set 118. In the illustrated example, the subset activation indication 120 identifies, PDCCH skipping duration subset 202(2), which the PDCCH monitoring control 124 activates. The PDCCH skipping duration subset 202(2) includes multiple skipping durations each of which is a value indicating an amount of time resources (e.g., slots) that the UE can skip monitoring. These values may take various forms, such as an amount of time (e.g., a number of milliseconds (ms)), a number of PDCCH candidate time resources (e.g., a number of slots or other time resources during which a PDCCH may be sent), and so forth. In the illustrated example, the PDCCH skipping duration subset 202(2) includes four skipping durations: A, B, C, and D. Two different PDCCH skipping duration subsets can share one or more PDCCH skipping durations but are at least different in one PDCCH skipping duration.

In the discussions herein, the time resources can be referred to as slots. Instead of “slot”, “mini-slot”, “subslot” or “aggregated slots” can also be used.

A skipping indication 122 is also received that identifies one of the possible skipping durations in a PDCCH skipping duration subset. In the illustrated example, the skipping indication 122 is two bits, allowing the skipping indication 122 to identify one of the four PDCCH skipping durations in the PDCCH skipping duration subset 202(2). In the illustrated example, the skipping indication 122 identifies the PDCCH skipping duration 204, which the PDCCH monitoring control 124 uses to skip PDCCH monitoring as discussed in more detail below.

Returning to FIG. 1, the techniques discussed herein provide a service-oriented design that reduces UE power consumption in various situations. For example, XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

PDCCH monitoring adaptation and search space set group switching techniques (e.g., via scheduling DCI or group-common DCI indication) can be used to reduce UE's power consumption by skipping PDCCH monitoring in some slots such as the slots where the network does not expect to schedule an UL, DL, or SL transmission. To keep the DCI size limited for the DCI indicating the PDCCH skipping duration, only a limited number of PDCCH skipping durations (e.g., up to 3 values from a configured set of possible values) can be indicated.

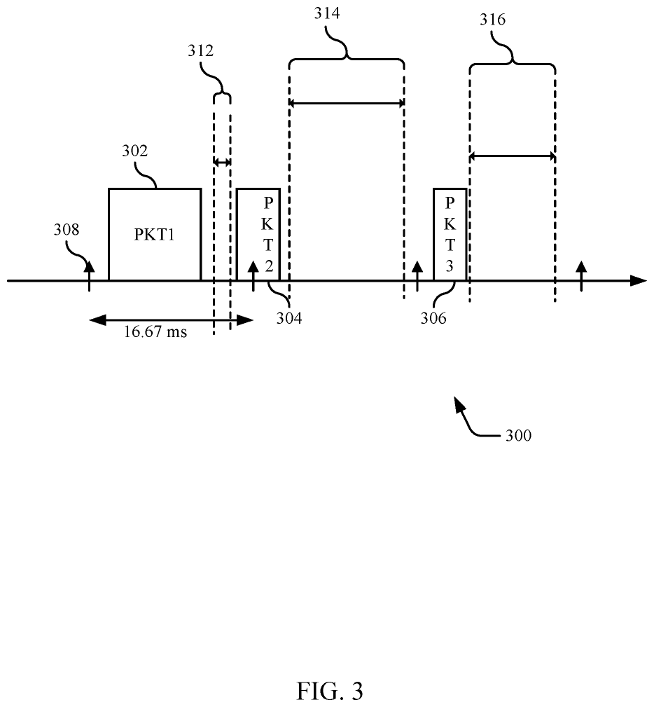

FIG. 3 illustrates an example 300 of potential ranges for PDCCH skipping. For XR traffic, e.g., as shown in the example 300, a potential range for PDCCH skipping is different from one video frame or application data unit (ADU) to another video frame or ADU due to one or more of the following:
the arrival times are pseudo-periodic or quasi-periodic instead of periodic due to traffic jitter;
the video frame or ADU sizes are different.
   An ADU refers to the smallest unit of data that can be processed independently by an application (such as processing for handling out-of-order traffic data).

As illustrated in the example 300, multiple packets (PKTs) 302, 304, and 306 are illustrated. These packets 302, 304, and 306 are, for example, video packets. At a frame generation rate of 60 frames per second (fps or FPS), video packets may be expected every 16.67 ms, illustrated as vertical arrows (e.g., arrow 308). However, due to jitter, the timing of when the packets arrive may vary, making it difficult to have a consistent range of PDCCH skipping duration. Furthermore, different video frame or ADU sizes also makes it difficult to have a consistent range of PDCCH skipping duration. For example, potential ranges of PDCCH skipping duration 312, 314, and 316 are shown in the example 300, with differences in the potential ranges of PDCCH skipping duration arising from these jitter and size factors.

To enable the network (e.g., the base station 102) to indicate a more relevant PDCCH skipping duration given the limited DCI field size for PDCCH skipping duration indication (e.g., at most 2 bits for PDCCH skipping), the techniques discussed herein provide mechanisms for the UE 104 to determine PDCCH monitoring occasions (or to-be-skipped PDCCH monitoring occasions) from a subset (e.g., containing at most 3 possible PDCCH skipping durations) of a larger set of configured RRC skipping durations (e.g., containing more than 3 possible PDCCH skipping durations). The subset is determined based on an indication such as a MAC-CE indication, or based on the XR traffic periodicity, jitter statistics and previous jitter realizations for a DL video transmission (assuming radio access network (RAN)/scheduler is aware of some XR traffic characteristics (e.g., traffic periodicity, jitter statistics for DL video transmissions)). In addition, the techniques discussed herein provide solutions to pause an indicated PDCCH skipping to allow PDCCH monitoring associated with UL transmissions (e.g., scheduling request (SR), UL control/pose).

The UE 104 can be indicated via PDCCH (scheduling an UL or DL or SL traffic or a group-common PDCCH such as DCI format 2_0) to stop monitoring PDCCH according to Type3-PDCCH CSS sets or USS sets for an indicated time duration (e.g., out of at most 3 possible durations and no skipping). The indication may be able to indicate to change search space sets being monitored to another search space sets. The UE may skip PDCCH monitoring or may switch the search space sets after a pre-determined delay from the time the indication is received (also referred to as application delay).

The UE 104 can be provided a group index for a respective Type3-PDCCH CSS set or USS set by searchSpaceGroupIdList for PDCCH monitoring on a serving cell. If the UE 104 is not provided searchSpaceGroupIdList for a search space set, the following procedures are not applicable for PDCCH monitoring according to the search space set.

If the UE 104 is provided cellGroupsForSwitchList, indicating one or more groups of serving cells, the following procedures apply to all serving cells within each group; otherwise, the following procedures apply only to a serving cell for which the UE 104 is provided searchSpaceGroupIdList.

When the UE 104 is provided searchSpaceGroupIdList, the UE 104 resets PDCCH monitoring according to search space sets with group index 0, if provided by searchSpaceGroupIdList.

The UE 104 can be provided by searchSpaceSwitchDelay a number of symbols P_{switch} where a minimum value of P_{switch} is provided in Table 1 for UE 104 processing capability 1 and UE 104 processing capability 2 and subcarrier spacing (SCS) configuration μ. UE 104 processing capability 1 for SCS configuration μ applies unless the UE 104 indicates support for UE 104 processing capability 2.

TABLE 1
Minimum value of P_{switch} [symbols]

| | Minimum P_{switch} | Minimum P_{switch} |
|---|---|---|
| | value for | value for |
| | UE processing | UE processing |
| | capability 1 | capability 2 |
| μ | [symbols] | [symbols] |
| 0 | 25 | 10 |
| 1 | 25 | 12 |
| 2 | 25 | 22 |
| 3 | 40 | — |
| 5 | 160 | — |
| 6 | 320 | — |

A UE 104 can be provided, by searchSpaceSwitchTimer, a timer value for a serving cell that the UE 104 is provided searchSpaceGroupIdList or, if provided, for a set of serving cells provided by cellGroupsForSwitchList. The UE 104 decrements the timer value by one after each slot based on a reference SCS configuration that is the smallest SCS configuration μ among all configured DL bandwidth parts (BWPs) in the serving cell, or in the set of serving cells. The UE 104 maintains the reference SCS configuration during the timer decrement procedure.

If a UE 104 is provided by SearchSpaceSwitchTrigger a location of a search space set group switching flag field for a serving cell in a DCI format 2_0,
if the UE 104 detects a DCI format 2_0 and a value of the search space set group switching flag field in the DCI format 2_0 is 0, the UE 104 starts monitoring PDCCH according to search space sets with group index 0, and stops monitoring PDCCH according to search space sets with group index 1, for the serving cell at a first slot that is at least P_{switch} symbols after the last symbol of the PDCCH with the DCI format 2_0,
if the UE 104 detects a DCI format 2_0 and a value of the search space set group switching flag field in the DCI format 2_0 is 1, the UE 104 starts monitoring PDCCH according to search space sets with group index 1, and stops monitoring PDCCH according to search space sets with group index 0, for the serving cell at a first slot that is at least P_{switch} symbols after the last symbol of the PDCCH with the DCI format 2_0, and the UE 104 sets the timer value to the value provided by searchSpaceSwitchTimer,
if the UE 104 monitors PDCCH for a serving cell according to search space sets with group index 1, the UE 104 starts monitoring PDCCH for the serving cell according to search space sets with group index 0, and stops monitoring PDCCH according to search space sets with group index 1, for the serving cell at the beginning of the first slot that is at least P_{switch} symbols after a slot where the timer expires or after a last symbol of a remaining channel occupancy duration for the serving cell if indicated by DCI format 2_0.

If a UE 104 is not provided SearchSpaceSwitchTrigger for a serving cell,
if the UE 104 detects a DCI format by monitoring PDCCH according to a search space set with group index 0, the UE 104 starts monitoring PDCCH according to search space sets with group index 1, and stops monitoring PDCCH according to search space sets with group index 0, for the serving cell at a first slot that is at least P_{switch} symbols after the last symbol of the PDCCH with the DCI format, the UE 104 sets the timer value to the value provided by searchSpaceSwitchTimer if the UE 104 detects a DCI format by monitoring PDCCH in any search space set,
if the UE 104 monitors PDCCH for a serving cell according to search space sets with group index 1, the UE 104 starts monitoring PDCCH for the serving cell according to search space sets with group index 0, and stops monitoring PDCCH according to search space sets with group index 1, for the serving cell at the beginning of the first slot that is at least P_{switch} symbols after a slot where the timer expires or, if the UE 104 is provided a search space set to monitor PDCCH for detecting a DCI format 2_0, after a last symbol of a remaining channel occupancy duration for the serving cell if indicated by DCI format 2_0

The UE 104 determines a slot and a symbol in the slot to start or stop PDCCH monitoring according to search space sets for a serving cell that the UE 104 is provided searchSpaceGroupIdList or, if cellGroupsForSwitchList is provided, for a set of serving cells, based on the smallest SCS configuration u among all configured DL BWPs in the serving cell or in the set of serving cells and, if any, in the serving cell where the UE 104 receives a PDCCH and detects a corresponding DCI format 2_0 triggering the start or stop of PDCCH monitoring according to search space sets.

The UE 104 can be provided a set of durations by PDCCHSkippingDurationList for PDCCH monitoring on a serving cell and, if the UE 104 is not provided searchSpaceGroupIdList-r17, a DCI format 0_1, and/or DCI format 1_1, and/or DCI format 0_2, and/or DCI format 1_2 that schedules a physical uplink shared channel (PUSCH) transmission or a physical downlink channel shared (PDSCH) reception can include a PDCCH monitoring adaptation field of 1 bit or of 2 bits.

If the field has 1 bit and for PDCCH monitoring according to Type3-PDCCH CSS sets or USS sets on the serving cell,
a ‘0’ value for the bit indicates no skipping in PDCCH monitoring,
a ‘1’ value for the bit indicates skipping PDCCH monitoring for a duration provided by the first value in the set of durations.

If the field has 2 bits and for PDCCH monitoring according to Type3-PDCCH CSS sets or USS sets on a serving cell,
a ‘00’ value for the bits indicates no skipping in PDCCH monitoring,
a ‘01’ value for the bits indicates skipping PDCCH monitoring for a duration provided by the first value in the set of durations,
a ‘10’ value for the bits indicates skipping PDCCH monitoring for a duration provided by the second value in the set of durations,
a ‘11’ value for the bits indicates skipping PDCCH monitoring for a duration provided by the third value in the set of durations, if any; otherwise, if the set of durations includes two values, a use of the ‘11’ value is reserved.

A UE 104 can be provided group indexes for a Type3-PDCCH CSS set or USS set by searchSpaceGroupIdList-r17 for PDCCH monitoring on a serving cell and, if the UE 104 is not provided PDCCHSkippingDurationList, DCI format 0_1, or DCI format 1_1, or DCI format 0_2, or DCI format 1_2 that schedules a PUSCH transmission or a PDSCH reception can include a PDCCH monitoring adaptation field of 1 bit or of 2 bits.

If the field has 1 bit and for PDCCH monitoring according to Type3-PDCCH CSS sets or USS sets on the serving cell,
a ‘0’ value for the bit indicates start of PDCCH monitoring according to search space sets with group index 0 and stop of PDCCH monitoring according to search space sets with other group indexes, if any,
a ‘1’ value for the bit indicates start of PDCCH monitoring according to search space sets with group index 1 and stop of PDCCH monitoring according to search space sets with other group indexes, if any.

If the field has 2 bits and for PDCCH monitoring according to Type3-PDCCH CSS sets or USS sets on the serving cell,
a ‘00’ value for the bit indicates start of PDCCH monitoring according to search space sets with group index 0 and stop of PDCCH monitoring according to search space sets with other group indexes, if any,
a ‘01’ value for the bit indicates start of PDCCH monitoring according to search space sets with group index 1 and stop of PDCCH monitoring according to search space sets with other group indexes, if any,
a ‘10’ value for the bit indicates start of PDCCH monitoring according to search space sets with group index 2 and stop of PDCCH monitoring according to search space sets with other group indexes, if any,
a ‘11’ value is reserved.

The UE 104 can be provided a set of durations by PDCCHSkippingDurationList and group indexes for a Type3-PDCCH CSS set or USS set by searchSpaceGroupIdList-r17 for PDCCH monitoring on a serving cell and, a DCI format 0_1, and/or DCI format 1_1, and/or DCI format 0_2, and/or DCI format 1_2 that schedules a PUSCH transmission or a PDSCH reception can include a PDCCH monitoring adaptation field of 2 bits.

If the set of durations includes one value and for PDCCH monitoring according to Type3-PDCCH CSS sets or USS sets on the serving cell
a ‘00’ value for the bit indicates start of PDCCH monitoring according to search space sets with group index 0 and stop of PDCCH monitoring according to search space sets with group index 1, if any,
a ‘01’ value for the bit indicates start of PDCCH monitoring according to search space sets with group index 1 and stop of PDCCH monitoring according to search space sets with group index 0, if any,
a ‘10’ value for the bits indicates skipping PDCCH monitoring for a duration provided by the value in the set of durations,
a ‘11’ value is reserved.

If the set of durations includes two values and for PDCCH monitoring according to Type3-PDCCH CSS sets or USS sets on the serving cell,
a ‘00’ value for the bit indicates start of PDCCH monitoring according to search space sets with group index 0 and stop of PDCCH monitoring according to search space sets with group index 1, if any,
a ‘01’ value for the bit indicates start of PDCCH monitoring according to search space sets with group index 1 and stop of PDCCH monitoring according to search space sets with group index 0, if any,
a ‘10’ value for the bits indicates skipping PDCCH monitoring for a duration provided by the first value in the set of durations,
a ‘11’ value for the bits indicates skipping PDCCH monitoring for a duration provided by the second value in the set of durations.

If a UE 104 is provided group indexes for a Type3-PDCCH CSS set or a USS set by searchSpaceGroupIdList-r17 and a timer value by searchSpaceSwitchTimer-r17 for PDCCH monitoring on a serving cell and the timer is running, the UE 104
decrements the timer after a slot of an active DL BWP of the serving cell when the UE 104 does not detect a DCI format in a PDCCH reception in the slot,
resets the timer after a slot of the active DL BWP of the serving cell when the UE 104 detects a DCI format in a PDCCH reception in the slot.

When the timer expires, the UE 104 monitors PDCCH on the serving cell according to search space sets with group index 0.

Extended reality is an umbrella term for different types of realities including virtual reality, augmented reality, and mixed reality. Virtual reality (VR) refers to a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

Augmented reality (AR) refers to when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

Extended reality refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Many of the XR and computer graphics (CG) use cases are characterized by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB).

The set of anticipated XR and CG services has a certain variety and characteristics of the data streams (i.e., video) may change “on-the-fly”, while the services are running over NR. Therefore, additional information on the running services from higher layers, e.g. the quality of service (QOS) flow association, frame-level QoS, ADU-based QOS, XR specific QoS etc., may be beneficial to facilitate informed choices of radio parameters. XR application awareness by the UE 104 and gNB improves the user experience, improves the NR system capacity in supporting XR services, and reduces the UE 104 power consumption.

For video such as XR, the packet arrival rate is determined by the frame generation rate, e.g., 60 fps. Accordingly, the average packet arrival periodicity is given by the inverse of the frame rate, e.g., 16.6667 ms= 1/60 fps. The periodic arrival without jitter gives the arrival time at the base station for packet with index k (=1, 2, 3 . . . ) as k/F*1000 [ms], where F is the given frame generation rates (per second). Note that this periodic packet arrival implicitly assumes fixed delay contributed from network side including fixed video encoding time, fixed network transfer delay, etc.

The varying frame encoding delay and network transfer time introduces jitter in packet arrival time at the base station, which in one or more implementations is modelled as a random variable added on top of periodic arrivals. The jitter follows truncated Gaussian distribution with statistical parameters shown in Table 2.

TABLE 2
Statistical parameters for jitter

| | | Baseline value for | Optional value for |
|---|---|---|---|
| Parameter | unit | evaluation | evaluation |
| Mean | ms | 0 | |
| STD | ms | 2 | |
| Truncation range | ms | [−4, 4] | [−5, 5] |

The given parameter values and considered frame generation rates (60 or 120 in this model) ensure that packet arrivals are in order (i.e., arrival time of a next packet is always larger than that of the previous packet). Thus, the periodic arrival with jitter gives the arrival time for packet with index k (=1, 2, 3 . . . ) as offset+k/F*1000+J [ms], where F is the given frame generation rates (per second) and J is a random variable capturing jitter. Note that actual traffic arrival timing of traffic for each UE 104 could be shifted by the UE 104 specific arbitrary offset.

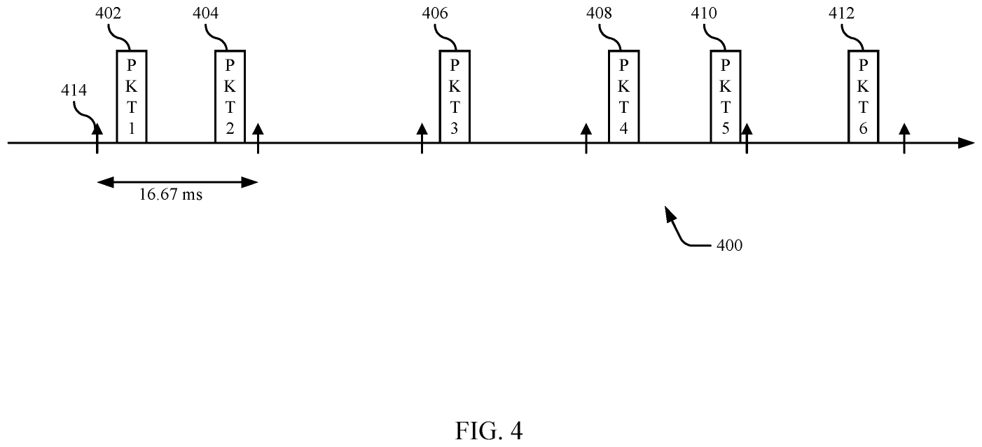

FIG. 4 illustrates an example 400 of XR traffic. Multiple packets 402, 404, 406, 408, 410, and 412 of XR traffic (e.g., video or CG data) are illustrated. At a frame generation rate of 60 frames per second (fps), video packets may be expected every 16.67 ms, illustrated as vertical arrows (e.g., arrow 414). However, as illustrated in the example 400, XR traffic is pseudo-periodic.

In one or more implementations as discussed herein, a UE 104 has received a DL packet on a DL BWP of a component carrier at time ‘t1’ and the packet is the last packet associated with an ADU/video frame. There is no outstanding DL data for the UE 104 to be scheduled on the BWP at a time ‘t2’ related to time ‘t1’. Additionally or alternatively, ‘t2’ can be determined based on a time ‘t3’ by which the base station has received an acknowledgment from the UE 104 in response to the DL packet.

After the transmission of a packet (such as packet 402) or reception of a positive acknowledgment from the UE 104 in response to the packet, the base station 102 can indicate PDCCH monitoring for the UE 104 can be skipped for a duration of time (e.g., based on XR traffic arrival periodicity). Some PDCCH skipping techniques allow the base station 102 to indicate a PDCCH skipping duration out of at most 3 RRC configured duration values (at most 2 bits in DCI for PDCCH skipping indication; no-PDCCH skipping can also be indicated, wherein one codepoint/state out of four possible codepoints/states that 2 bits in the DCI can indicate for PDCCH skipping indicates no-PDCCH skipping). The techniques discussed herein extend or expand the possible values for PDCCH skipping duration while keeping the DCI field size for the PDCCH skipping limited (e.g., at most 2 bits).

This extension of potential PDCCH skipping duration values is allowed by configuring a larger set of skipping duration values and the UE 104 determines the PDCCH skipping duration based on various factors, for example at least three of the following:
a value indicated in the skipping indication,
the set of configured PDCCH skipping duration values,
a MAC-CE indication activating or deactivating a subset of the set of configured PDCCH skipping duration values,
a set of previously received packets (e.g., a set of jitter values associated to the set of previously received packets), and
traffic (e.g., XR traffic) characteristics such as video frame per second rate, traffic arrival jitter statistics.

Various different control signaling is discussed herein, such as control signaling transmitted from a base station 102 and received by a UE 104. Such control signaling can include any combination of RRC, DCI, MAC-CE, or the like. Different control signaling may be discussed as indicating different control information (e.g., indicating a set of durations associated with skipping of monitoring for a PDCCH, indicating to activate a subset of durations of a set of durations, indicating for the UE 104 to terminate monitoring a set of PDCCH candidates associated with a PDCCH, indicating a configuration for a search space set within the set of PDCCH candidates, and so forth). Different control signaling can be the same or different type. E.g., one control signaling may be MAC-CE while another control signalling may be RRC or DCI.

In one or more implementations, the UE 104 receives a configured set of PDCCH skipping durations, such as via a control signaling from a base station 102. The UE 104 receives a MAC-CE indication activating a particular subset of the configured set of PDCCH skipping durations, such as via a control signaling from a base station 102. The UE 104 receives a DCI, such as via a control signaling from a base station 102, indicating to skip PDCCH monitoring for a duration chosen from at least the particular subset of PDCCH skipping durations, if the particular subset of PDCCH is a valid subset. The UE 104 skips PDCCH monitoring for the duration for a serving cell.

In one or more implementations, the maximum cardinality of the set of configured PDCCH skipping duration values is a pre-determined value, e.g., fixed in the specifications as 64 or a multiple of 8 and/or a multiple of 3.

In one or more implementations, the MAC-CE indication is scheduled by the DCI. Additionally or alternatively, the MAC-CE indication is included in the PDSCH that is scheduled via the DCI.

In one or more implementations, the MAC-CE includes a field corresponding to each configured PDCCH skipping durations. A value ‘1’ for the field indicates the corresponding PDCCH skipping duration is activated and included in the particular subset and a value ‘0’ for the field indicates the corresponding PDCCH skipping duration is de-activated and not included in the particular subset of PDCCH skipping durations. Additionally or alternatively, the MAC-CE includes the serving cell ID. Additionally or alternatively, the MAC-CE includes fields corresponding to configured PDCCH skipping durations associated with different serving cells.

In one or more implementations, the UE 104 starts skipping PDCCH monitoring for the duration after a determined time instance, where the determined time instance is a time instance that is at least after the transmission time of a positive acknowledgment in response to the reception of a PDSCH containing the MAC-CE indication, or the determined time instance is the first slot that is after slot ‘n+3N’, wherein ‘n’ is the slot the UE transmitted the positive acknowledgment in response to the MAC-CE, and ‘N’ is dependent on the SCS of the physical uplink control channel (PUCCH) that the positive acknowledgment is transmitted on (e.g., N=1 for 15 Kilo-Hertz (KHz) SCS, corresponding to mu=0). The transmission time of the positive acknowledgment is not before a threshold time from the time the DCI is received (to reduce the chance of using an outdated MAC-CE in case the UE misses the most recent MAC-CE). The threshold time can be configured. The subset is not valid if the transmission time of the positive acknowledgment is before the threshold time or no positive acknowledgment has been transmitted or generated at all in response to the reception of the MAC-CE indication.

In one or more implementations, the DCI (or a higher layer signaling such as RRC signaling) indicates whether the indicated PDCCH skipping duration applies after the positive acknowledgment in response to the reception of a PDSCH containing the MAC-CE indication.

In one or more implementations, the cardinality of the subset is ‘K’ or the associated number of bits ‘M’ is indicated via higher layer signaling such as RRC signaling or via UE capability reporting, where ‘M=ceil(log 2(K))’, and ceil(x) rounds ‘x’ to the nearest integer that is larger than ‘x’.

In one or more implementations, the DCI is received on the serving cell.

In one or more implementations, the hybrid automated repeat request-acknowledgement (HARQ-ACK) generated in response to the reception of the MAC-CE is associated with a high-priority for collision/overlap handling between two UL transmissions including a PUSCH or a PUCCH that carries the HARQ-ACK.

In one or more implementations, the subset includes no skipping or zero skipping duration or one code-point of the possible skipping durations that can be indicated via the DCI indicates no PDCCH skipping or zero skipping duration or the duration can be zero.

In one or more implementations, the cardinality of the subset excluding the no skipping indication, is at most a predetermined number, e.g., 1, or 3, or 7.

In one or more implementations, the duration can also be chosen from a set of RRC configured PDCCH skipping durations, where the RRC configured set of PDCCH skipping durations and the subset of the PDCCH skipping durations are different or do not share any common value. The set of RRC configured PDCCH skipping durations can include values that are common to all PDCCH skipping indications (e.g., a certain bit combinations in the DCI for the PDCCH skipping indication/PDCCH monitoring adaptation field indicate the common values for PDCCH skipping durations, and the rest of bit combinations indicate PDCCH skipping durations from the subset).

In one or more implementations, a default subset of the configured set of PDCCH skipping durations can be determined, e.g., via RRC configuration. The duration is chosen from the default subset if the subset is not valid, or after the configuration of the configured set of PDCCH skipping durations, and/or after a handover event, and/or if there is no activated/active subset of PDCCH skipping durations, e.g., the UE has received a MAC-CE indicating a subset of the PDCCH skipping durations is de-activated.

In one or more implementations, a UE 104 receives a set of PDSCHs in a set of arrival times, such as via one or more control signaling from a base station 102. The UE 104 determines a set of jitter values based on the set of arrival times and a set of pre-determined periodic time instances. The UE 104 receives a DCI (or other control signaling) indicating an index associated with a set of configured PDCCH skipping durations, where the set of configured PDCCH skipping durations includes ‘K’ skipping duration values. The UE 104 determines a PDCCH skipping duration based on the index, the set of configured PDCCH skipping durations, and the set of jitter values and/or jitter statistics (e.g., driven from the set of jitter values).

The UE 104 determines the set of jitter values corresponding to the transmissions associated with initial transport block (TB) transmissions (not the retransmissions as the TB associated with a retransmission is already available in the gNB buffer). The cardinality of the set of jitter values is predetermined (e.g., via specification), configured (e.g., via RRC signaling), indicated (e.g., via MAC-CE or DCI signaling), or reported by the UE (e.g., via capability signaling). The set of jitter values includes at least the most recent jitter value.

The UE 104 determines a PDCCH skipping duration based at least in part on the jitter (e.g., jitter values and/or jitter statistics). The UE 104 determines a reference skipping duration based at least in part on the time that the UE 104 received the DCI (or based on the time that the UE 104 sent a positive acknowledgment in response to the scheduled PDSCH by the DCI), jitter statistics and/or the set of jitter values, an application delay associated with the DCI, and the periodicity of the pre-determined periodic time instances. The UE 104 determines, based at least in part on the reference skipping duration and the indicated index corresponding to PDCCH skipping in the DCI, the PDCCH skipping duration.

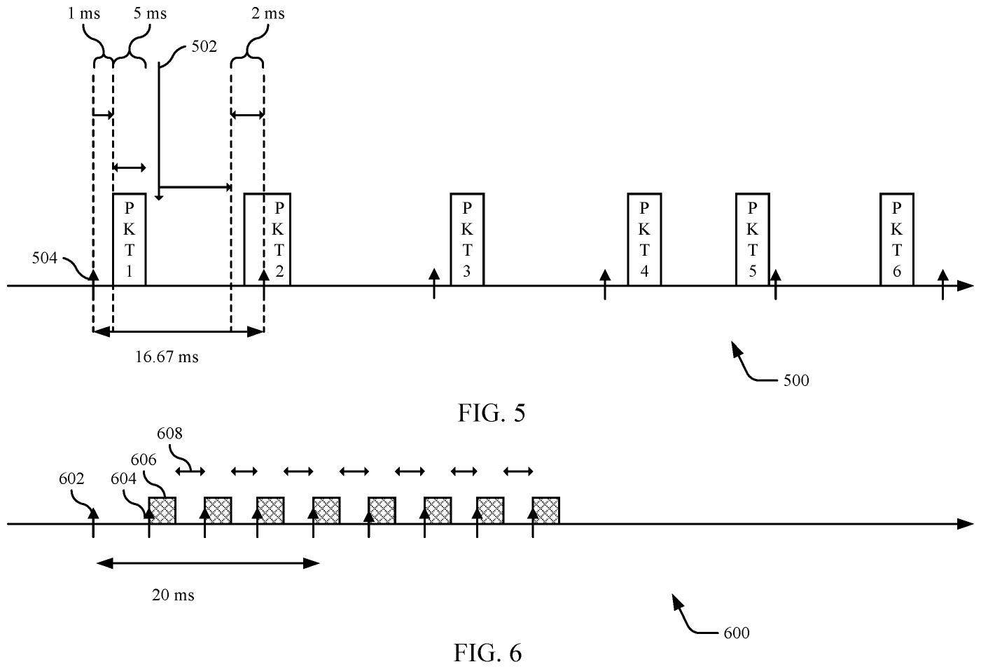

FIG. 5 illustrates an example 500 of determining the PDCCH skipping value based at least in part on jitter. In the example 500, a 60 FPS video frame rate is assumed. A skipping indication 502 is received at 6.67 ms after the start of a 16.67 ms cycle ( 1/60 FPS). The 16.67 ms cycles are illustrated by vertical arrows (e.g., arrow 504). Based on the jitter statistics, a maximum potential skipping duration ends 2 ms before the start of the next cycle, illustrated at 506. Considering an application delay of 1 ms, the UE 104 calculates a reference PDCCH skipping duration to be 7 ms in this example: 16.67−6.67−2−1=7 ms (16.67 ms cycle minus 6.67 ms after start that the skipping indication 502 is received minus 2 ms jitter-based maximum potential skipping duration end minus 1 ms application delay).

The UE 104 constructs a set of possible PDCCH skipping durations based on the determined reference PDCCH skipping duration. For instance, for 2-bit PDCCH skipping indication in the DCI, the UE 104 constructs the set as: example_set1: {0, 7−D1, 7, 7+D2} or example_set2: {0, 7−D1, 7−D3, 7} or example_set3: {0, 7*e1, 7*e2, and 7}, etc.; where D1, D2, D3, e1, and e2 can be determined from a higher layer signaling or from the jitter statistics or the set of jitter realizations/values. The UE 104 then determines a PDCCH skipping duration from the constructed set based on the indication in the DCI. For instance, if the DCI indicates index 3 out of 4 indices, then the UE would choose 7 in example_set1, 7−D3 in example_set2, and 7*e2 in example_set3.

For some traffic (e.g., XR traffic), a UE 104 can transmit UL pose or XR-related control information periodically (e.g., with 4 ms periodicity) with small packet size (e.g., 100 bytes) according to a delay or latency budget (e.g., 10 ms). The UE 104 may monitor PDCCH in a specific search space aligned with, determined by, or associated with pose arrival. For instance, base station 102 can schedule a pose retransmission in case of not receiving a pose.

In one or more implementations, in the example 500 of FIG. 5, to still harvest power saving via PDCCH skipping, the UE 104 can receive PDCCH skipping indications multiple times (e.g., 2 or 3 times for durations indicated as potential skipping durations, such as the time between receipt of the skipping indication 502 and 2 ms before the start of the next cycle) within every video frame period (e.g., 16.67 ms). Sending multiple PDCCH skipping indications, however, can introduce additional delay (e.g., resulting from an application delay). For instance, if there is 1 ms application delay associated with each PDCCH skipping indication, sending two or three PDCCH skipping indications instead of one PDCCH skipping indication would prevent PDCCH skipping for one or two additional milliseconds, respectively.

In one or more implementations, the UE 104 monitors one or more search space sets that is (or are) configured after or around each pose or control transmission instance irrespective of receiving any PDCCH skipping command. For example, the UE 104 monitors PDCCH in a search space set (e.g., every 1 or 2 ms after transmitting a UL pose or XR-related control information) even though that search space set is within a PDCCH skipping duration signaled by the base station 102. Essentially, that search space set is excluded from the PDCCH skipping duration signaled by the base station 102.

FIG. 6 illustrates an example 600 of monitoring PDCCH after a transmission. In the example 600, pose or XR-related control information is transmitted at the times indicated by the vertical arrows (e.g., arrows 602 and 604). The UE 104 monitors PDCCH after each arrow, shown by boxes with cross-hatching (e.g., box 606). The UE 104 terminates monitoring of PDCCH in the times between the boxes, shown by the horizontal arrows (e.g., arrow 608).

In one or more implementations, the UE 104 is configured with a search space set and is indicated via a NOTSKIP indication not to skip the search space set upon reception of a PDCCH skipping command.

In one or more implementations, the NOTSKIP indication is indicated by RRC signaling (e.g., as part of search space set configuration of the search space set). Additionally or alternatively, the NOTSKIP indication is indicated by a MAC-CE indication (e.g., the search space ID of the search space set and the serving cell ID associated with the search space set are included in the MAC-CE command). Additionally or alternatively, the NOTSKIP indication is indicated by a DCI indication, such as the DCI containing a PDCCH skipping command. The DCI can indicate the search space set ID that is excluded from PDCCH skipping. A subset of search space set IDs could be indicated via a MAC-CE command, and the DCI would indicate one from the subset of search space set IDs. Alternatively, one or more search space sets is (or are) configured with a flag or a group-ID, and the DCI indicates whether the PDCCH skipping command applies to the one or more search space set(s). For instance, the DCI may indicate the group-ID, and the UE 104 based on the group-ID would determine the search space sets that are excluded from skipping command.

In one or more implementations, the UE 104 stops or pauses PDCCH skipping a certain time before each monitoring occasion associated with the search space set (e.g., to ensure the search space set can be monitored at the desired time).

In one or more implementations, the search space set is associated with a USS.

Similar to UL pose/control information, in one or more implementations the UE 104 monitors PDCCH after an UL video transmission or after an SR transmission (for potential UL grants). The UL video transmission can occur at periodic time instances (without jitter) or quasi-periodic time instances (periodic time instance shifted by a positive, negative, or zero value due to traffic jitter similar to the discussion above for DL traffic). The UE 104 can be configured with SR resources occurring close or prior to the periodic time instances. Upon transmission of a positive SR, the UE 104 would stop or pause PDCCH skipping for a duration of time, referred to as pause duration.

In one or more implementations, the UE 104 is configured with a SR configuration configuring a set of SR resources. The UE 104 receives a PDCCH skipping command to skip PDCCH monitoring for a duration of time. The UE 104 transmits a positive SR indication, wherein the indication is sent within the duration of time. A not skipping PDCCH monitoring for a window of time that overlaps with the duration is determined, where the window of time starts a certain time after the SR indication.

In one or more implementations, the duration of the window of time is RRC configured. Additionally or alternatively, the duration of the window of time is or spans the first set of PDCCH monitoring occasions (e.g., PDCCH candidates) after the SR transmission.

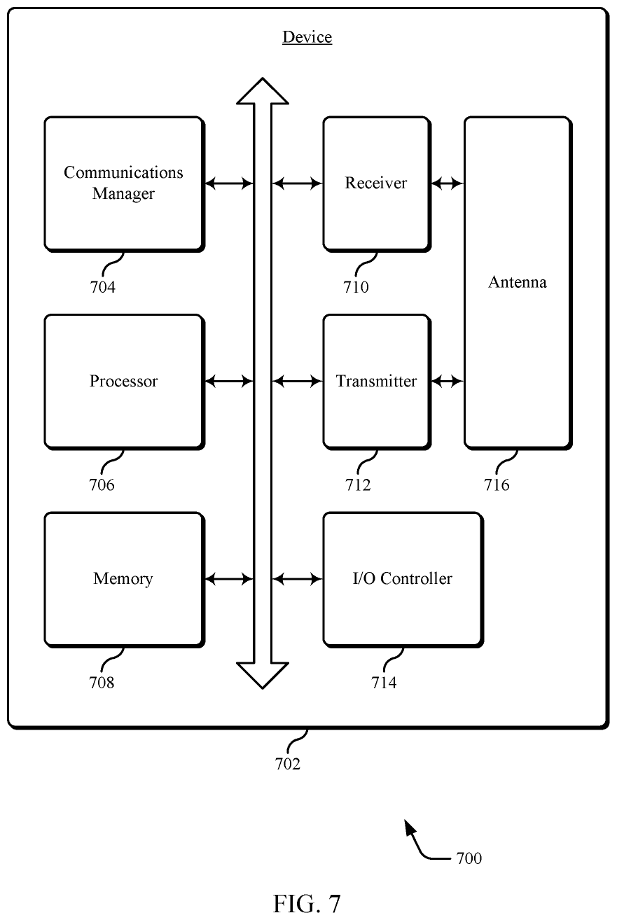

FIG. 7 illustrates an example of a block diagram 700 of a device 702 that supports expanded skipping of PDCCH monitoring in accordance with aspects of the present disclosure. The device 702 may be an example of a UE 104 as described herein. The device 702 may support wireless communication and/or network signaling with one or more base stations 102, other UEs 104, or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a UE) in accordance with examples as disclosed herein. The communications manager 704 and/or other device components may be configured as or otherwise support an apparatus, such as a UE, including a receiver to: receive, from a base station, first control signaling indicating a set of durations associated with skipping of monitoring for a PDCCH; receive, from the base station, second control signaling indicating to activate a first subset of durations of the set of durations; receive, from the base station, third control signaling indicating for the apparatus to terminate monitoring a set of PDCCH candidates associated with the PDCCH, according to a set of DCI formats for a serving cell, during a first time duration associated with the first subset of durations; and a processor, coupled to the receiver, the processor and the receiver configured to cause the apparatus to: terminate monitoring the set of PDCCH candidates associated with the PDCCH during the first time duration associated with the first subset of durations based at least in part on the received third control signaling.

Additionally, the apparatus (e.g., a UE) includes any one or combination of: where the second control signaling is a MAC-CE indication; where the MAC-CE is scheduled via the PDCCH; where the processor and the receiver are further configured to cause the apparatus to: determine whether the first subset of durations is valid for the third control signaling; and in response to determining the first subset of durations is valid, terminate monitoring the set of PDCCH candidates during the first time duration; where the second control signaling is a MAC-CE, and where, to determine whether the first subset of durations is valid for the third control signaling, the processor and the receiver are further configured to cause the apparatus to determine that the first subset of durations is valid if a positive acknowledgment is generated in response to the MAC-CE and the positive acknowledgment is not sent to the base station earlier than a threshold time; where the processor and the receiver are further configured to cause the apparatus to: determine a default subset of durations of the set of durations; and in response to determining the first subset of durations is not valid for the third control signaling, terminate monitoring the set of PDCCH candidates associated with the PDCCH during a second time duration associated with the default subset of durations based at least in part on the received third control signaling; where the processor and the receiver are further configured to determine to terminate monitoring the set of PDCCH candidates associated with the PDCCH during the first time duration associated with the first subset of durations based at least in part on the received third control signaling, and traffic jitter statistics or a set of traffic jitter values; where the processor and the receiver are further configured to: receive, from the base station, a fourth control signaling; and determine the traffic jitter statistics or the set of traffic jitter values based at least in part on the received fourth control signaling; where the processor and the receiver are further configured to: receive a configuration for a first search space set within the set of PDCCH candidates; receive a second indication via a MAC-CE indicating to not skip the first search space set upon reception of the third control signaling, the MAC-CE further including a search space set ID corresponding to the first search space set; and exclude a time associated with the first search space set from the first time duration.

The communications manager 704 and/or other device components may be configured as or otherwise support a means for wireless communication and/or network signaling at a UE, including receiving, from a base station, first control signaling indicating a set of durations associated with skipping monitoring for a PDCCH; receiving, from the base station, second control signaling indicating to activate a first subset of durations of the set of durations; receiving, from the base station, third control signaling indicating for the UE to terminate monitoring a set of PDCCH candidates associated with the PDCCH, according to a set of DCI formats for a serving cell, during a first time duration associated with the first subset of durations; and terminate monitoring the set of PDCCH candidates associated with the PDCCH during the first time duration associated with the first subset of durations based at least in part on the received third control signaling.

Additionally, wireless communication at the UE includes any one or combination of: where the second control signaling is a MAC-CE indication; where the MAC-CE is scheduled via the PDCCH; further including: determining whether the first subset of durations is valid for the third control signaling; and in response to determining the first subset of durations is valid, terminate monitoring the set of PDCCH candidates during the first time duration; further including: determining a default subset of durations of the set of durations; and in response to determining the first subset of durations is not valid for the third control signaling, terminate monitoring the set of PDCCH candidates associated with the PDCCH during a second time duration associated with the default subset of durations based at least in part on the received third control signaling; further including determining to terminate monitoring the set of PDCCH candidates associated with the PDCCH during the first time duration associated with the first subset of durations based at least in part on the received third control signaling, and traffic jitter statistics or a set of traffic jitter values; further including: receiving a configuration for a first search space set within the set of PDCCH candidates; receiving a MAC-CE indicating to not skip the first search space set upon reception of the third control signaling, the MAC-CE further including a search space set ID corresponding to the first search space set; and excluding a time associated with the first search space set from the first time duration; where the second control signaling is a MAC-CE, and where determining whether the first subset of durations is valid for the third control signaling includes determining that the first subset of durations is valid if a positive acknowledgment is generated in response to the MAC-CE and the positive acknowledgment is not sent to the base station earlier than a threshold time; further including: receiving, from the base station, a fourth control signaling; and determining the traffic jitter statistics or the set of traffic jitter values based at least in part on the received fourth control signaling.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

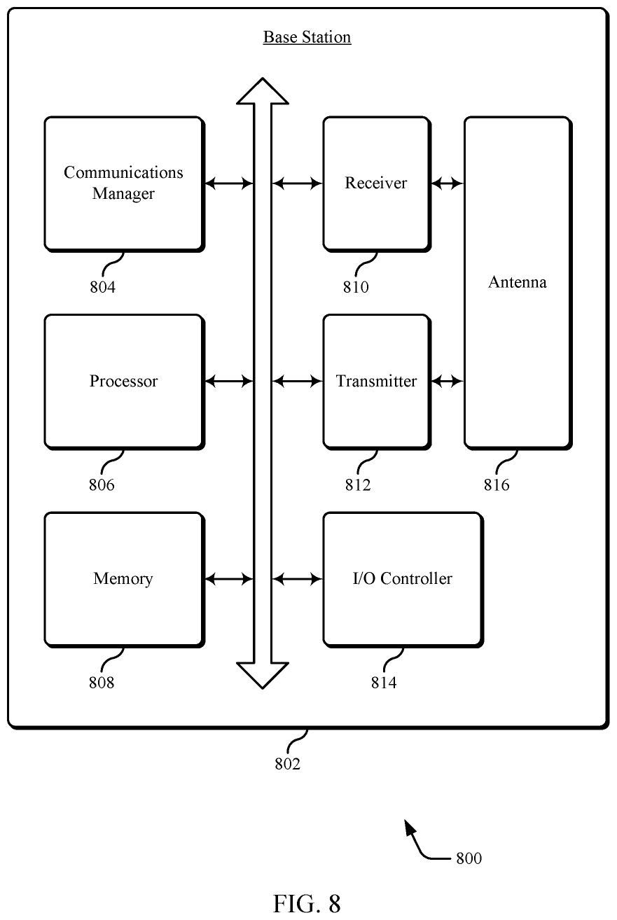

FIG. 8 illustrates an example of a block diagram 800 of a device 802 that supports expanded skipping of PDCCH monitoring in accordance with aspects of the present disclosure. The device 802 may be an example of a base station 102, such as a gNB as described herein. The device 802 may support wireless communication and/or network signaling with one or more base stations 102, other UEs 104, or any combination thereof. The device 802 may include components for bi-directional communications including components for transmitting and receiving communications, such as a communications manager 804, a processor 806, a memory 808, a receiver 810, a transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication and/or network signaling at a device (e.g., the device 802, base station) in accordance with examples as disclosed herein. The communications manager 804 and/or other device components may be configured as or otherwise support an apparatus, such as a base station, including a transmitter to: transmit, to a UE, first control signaling indicating a set of skipping durations associated with skipping of monitoring for a PDCCH; transmit, to the UE, second control signaling indicating to activate a first subset of durations of the set of durations; transmit, to the UE, third control signaling indicating for the UE to terminate monitoring a set of PDCCH candidates associated with the PDCCH, according to a set of DCI formats for a serving cell, during a first time duration associated with the first subset of durations; and a processor, coupled to the transmitter, the processor and the transmitter configured to cause the apparatus to: terminate transmitting DCI messages to the UE during the first time duration associated with the first subset of durations.

Additionally, the apparatus (e.g., a base station) includes any one or combination of: where the second control signaling is a MAC-CE; where the MAC-CE is scheduled via the PDCCH; where the processor and the transmitter are further configured to: transmit, to the UE, a fourth control signaling indicating a configuration for a first search space set within the set of PDCCH candidates; transmit, to the UE, a MAC-CE indicating to not skip the first search space set upon reception of the third control signaling, the MAC-CE further including a search space set ID corresponding to the first search space set; and exclude a time associated with the first search space set from the first time duration.

The communications manager 804 and/or other device components may be configured as or otherwise support a means for wireless communication and/or network signaling at a base station, including transmitting, to a UE, first control signaling indicating a set of skipping durations associated with skipping of monitoring for a PDCCH; transmitting, to the UE, second control signaling indicating to activate a first subset of durations of the set of durations; transmitting, to the UE, third control signaling indicating for the UE to terminate monitoring a set of PDCCH candidates associated with the PDCCH, according to a set of DCI formats for a serving cell, during a first time duration associated with the first subset of durations; and terminate transmitting DCI messages to the UE during the first time duration associated with the first subset of durations.

Additionally, wireless communication at the UE includes any one or combination of: where the second control signaling is a MAC-CE; where the MAC-CE is scheduled via the PDCCH; further including: transmitting, to the UE, a fourth control signaling indicating a configuration for a first search space set within the set of PDCCH candidates; transmitting, to the UE, a MAC-CE indicating to not skip the first search space set upon reception of the third control signaling, the MAC-CE further including a search space set ID corresponding to the first search space set; and excluding a time associated with the first search space set from the first time duration.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

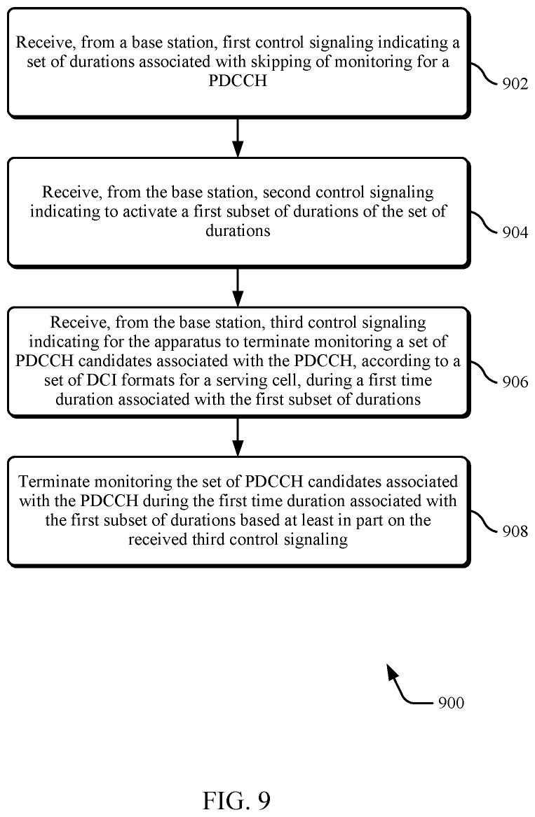

FIG. 9 illustrates a flowchart of a method 900 that supports expanded skipping of PDCCH monitoring in accordance with aspects of the present disclosure. The operations of the method 900 may be implemented by a device or its components as described herein. For example, the operations of the method 900 may be performed by a device, such as UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving, from a base station, first control signaling indicating a set of durations associated with skipping of monitoring for a PDCCH. The operations of 902 may be performed in accordance with examples as described herein. In some implementations, aspects of the operations of 902 may be performed by a device as described with reference to FIG. 1.

At 904, the method may include receiving, from the base station, second control signaling indicating to activate a first subset of durations of the set of durations. The operations of 904 may be performed in accordance with examples as described herein. In some implementations, aspects of the operations of 904 may be performed by a device as described with reference to FIG. 1.

At 906, the method may include receiving, from the base station, third control signaling indicating for the apparatus to terminate monitoring a set of PDCCH candidates associated with the PDCCH, according to a set of DCI formats for a serving cell, during a first time duration associated with the first subset of durations. The operations of 906 may be performed in accordance with examples as described herein. In some implementations, aspects of the operations of 906 may be performed by a device as described with reference to FIG. 1.

At 908, the method may include terminate monitoring the set of PDCCH candidates associated with the PDCCH during the first time duration associated with the first subset of durations based at least in part on the received third control signaling. The operations of 908 may be performed in accordance with examples as described herein. In some implementations, aspects of the operations of 908 may be performed by a device as described with reference to FIG. 1.

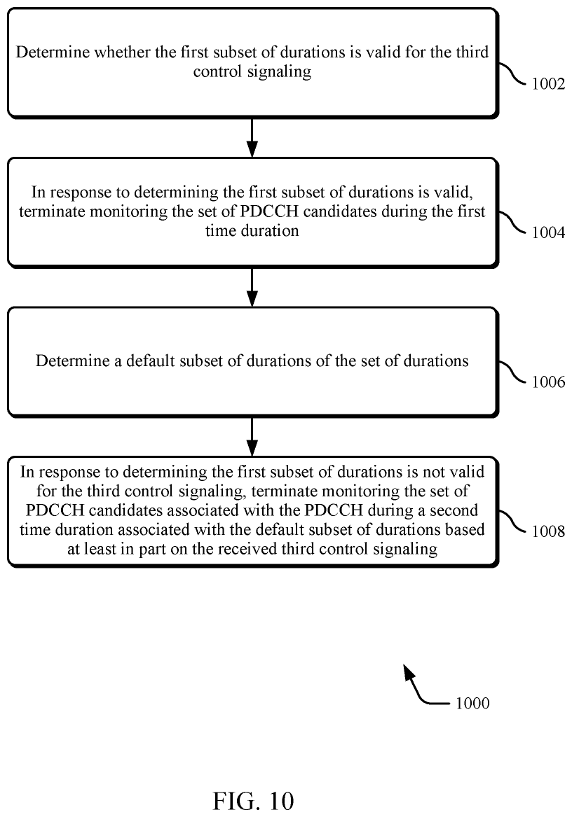

FIG. 10 illustrates a flowchart of a method 1000 that supports expanded skipping of PDCCH monitoring in accordance with aspects of the present disclosure. The operations of the method 1000 may be implemented by a device or its components as described herein. For example, the operations of the method 1000 may be performed by a device, such as UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include determining whether the first subset of durations is valid for the third control signaling. The operations of 1002 may be performed in accordance with examples as described herein. In some implementations, aspects of the operations of 1002 may be performed by a device as described with reference to FIG. 1.

At 1004, the method may include in response to determining the first subset of durations is valid, terminate monitoring the set of PDCCH candidates during the first time duration. The operations of 1004 may be performed in accordance with examples as described herein. In some implementations, aspects of the operations of 1004 may be performed by a device as described with reference to FIG. 1.

At 1006, the method may include determine a default subset of durations of the set of durations. The operations of 1006 may be performed in accordance with examples as described herein. In some implementations, aspects of the operations of 1006 may be performed by a device as described with reference to FIG. 1.

At 1008, the method may include in response to determining the first subset of durations is not valid for the third control signaling, terminate monitoring the set of PDCCH candidates associated with the PDCCH during a second time duration associated with the default subset of durations based at least in part on the received third control signaling. The operations of 1008 may be performed in accordance with examples as described herein. In some implementations, aspects of the operations of 1008 may be performed by a device as described with reference to FIG. 1.

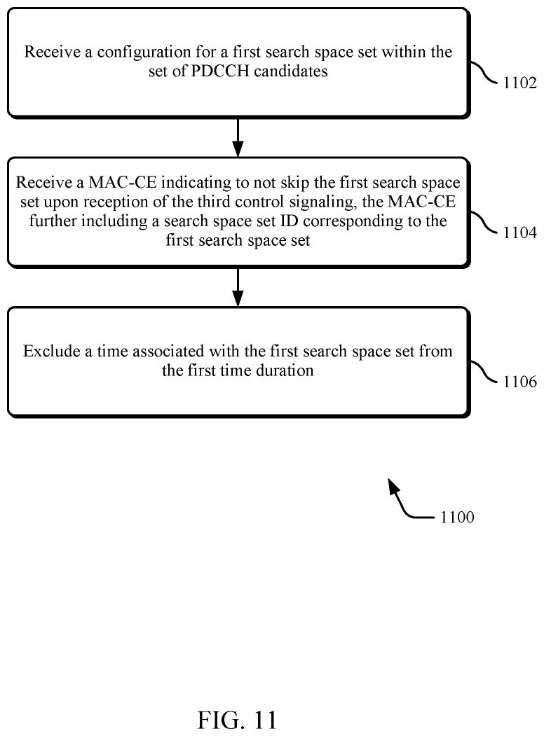

FIG. 11 illustrates a flowchart of a method 1100 that supports expanded skipping of PDCCH monitoring in accordance with aspects of the present disclosure. The operations of the method 1100 may be implemented by a device or its components as described herein. For example, the operations of the method 1100 may be performed by a device, such as UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving a configuration for a first search space set within the set of PDCCH candidates. The operations of 1102 may be performed in accordance with examples as described herein. In some implementations, aspects of the operations of 1102 may be performed by a device as described with reference to FIG. 1.

At 1104, the method may include receiving a MAC-CE indicating to not skip the first search space set upon reception of the third control signaling, the MAC-CE further including a search space set ID corresponding to the first search space set. The operations of 1104 may be performed in accordance with examples as described herein. In some implementations, aspects of the operations of 1104 may be performed by a device as described with reference to FIG. 1.

At 1106, the method may include excluding a time associated with the first search space set from the first time duration. The operations of 1106 may be performed in accordance with examples as described herein. In some implementations, aspects of the operations of 1106 may be performed by a device as described with reference to FIG. 1.

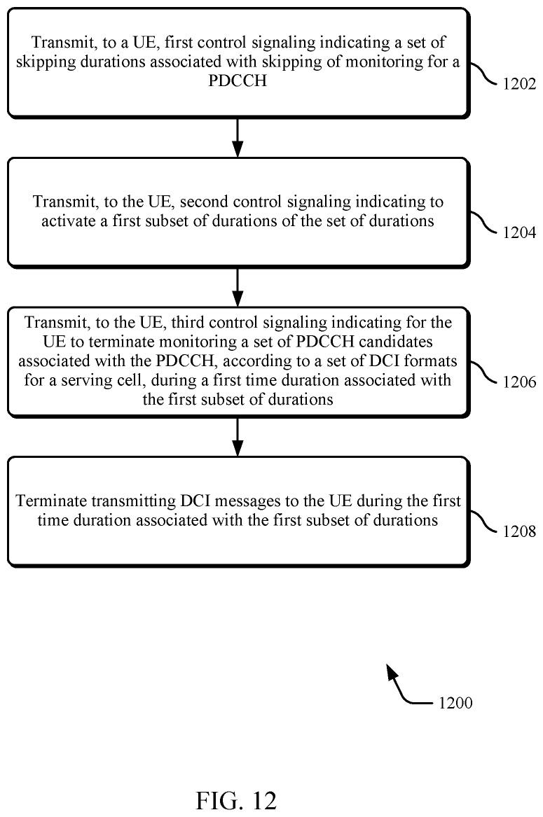

FIG. 12 illustrates a flowchart of a method 1200 that supports expanded skipping of PDCCH monitoring in accordance with aspects of the present disclosure. The operations of the method 1200 may be implemented by a device or its components as described herein. For example, the operations of the method 1200 may be performed by a base station 102, such as a gNB as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include transmitting, to a UE, first control signaling indicating a set of skipping durations associated with skipping of monitoring for a PDCCH. The operations of 1202 may be performed in accordance with examples as described herein. In some implementations, aspects of the operations of 1202 may be performed by a device as described with reference to FIG. 1.

At 1204, the method may include transmitting, to the UE, second control signaling indicating to activate a first subset of durations of the set of durations. The operations of 1204 may be performed in accordance with examples as described herein. In some implementations, aspects of the operations of 1204 may be performed by a device as described with reference to FIG. 1.

At 1206, the method may include transmitting, to the UE, third control signaling indicating for the UE to terminate monitoring a set of PDCCH candidates associated with the PDCCH, according to a set of DCI formats for a serving cell, during a first time duration associated with the first subset of durations. The operations of 1206 may be performed in accordance with examples as described herein. In some implementations, aspects of the operations of 1206 may be performed by a device as described with reference to FIG. 1.

At 1208, the method may include terminate transmitting DCI messages to the UE during the first time duration associated with the first subset of durations. The operations of 1208 may be performed in accordance with examples as described herein. In some implementations, aspects of the operations of 1208 may be performed by a device as described with reference to FIG. 1.

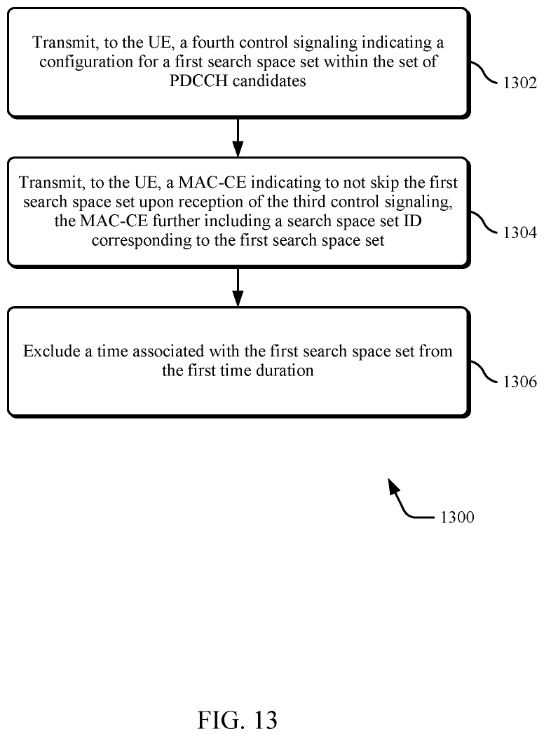

FIG. 13 illustrates a flowchart of a method 1300 that supports expanded skipping of PDCCH monitoring in accordance with aspects of the present disclosure. The operations of the method 1300 may be implemented by a device or its components as described herein. For example, the operations of the method 1300 may be performed by a base station 102, such as a gNB as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include transmitting, to the UE, a fourth control signaling indicating a configuration for a first search space set within the set of PDCCH candidates. The operations of 1302 may be performed in accordance with examples as described herein. In some implementations, aspects of the operations of 1302 may be performed by a device as described with reference to FIG. 1.

At 1304, the method may include transmitting, to the UE, a MAC-CE indicating to not skip the first search space set upon reception of the third control signaling, the MAC-CE further including a search space set ID corresponding to the first search space set. The operations of 1304 may be performed in accordance with examples as described herein. In some implementations, aspects of the operations of 1304 may be performed by a device as described with reference to FIG. 1.

At 1306, the method may include excluding a time associated with the first search space set from the first time duration. The operations of 1306 may be performed in accordance with examples as described herein. In some implementations, aspects of the operations of 1306 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive, from a base station, first control signaling indicating a set of durations associated with skipping of monitoring for a physical downlink control channel (PDCCH);
receive, from the base station, second control signaling indicating to activate a first subset of durations of the set of durations;
receive, from the base station, third control signaling indicating for the UE to terminate monitoring a set of PDCCH candidates associated with the PDCCH, according to a set of downlink control information (DCI) formats for a serving cell, during a first time duration associated with the first subset of durations; and
terminate monitoring the set of PDCCH candidates associated with the PDCCH during the first time duration associated with the first subset of durations based at least in part on the received third control signaling.

2. The UE of claim 1, wherein the second control signaling is a medium access control-control element (MAC-CE).

3. The UE of claim 2, wherein the MAC-CE is scheduled via the PDCCH.

4. The UE of claim 1, wherein the at least one processor is further configured to cause the UE to:
determine whether the first subset of durations is valid for the third control signaling; and
in response to determining the first subset of durations is valid, terminate monitoring the set of PDCCH candidates during the first time duration.

5. The UE of claim 4, wherein the second control signaling is a medium access control-control element (MAC-CE), and wherein, to determine whether the first subset of durations is valid for the third control signaling, the at least one processor is further configured to cause the UE to determine that the first subset of durations is valid if a positive acknowledgment is generated in response to the MAC-CE and the positive acknowledgment is not sent to the base station earlier than a threshold time.

6. The UE of claim 4, wherein the at least one processor is further configured to cause the UE to:
determine a default subset of durations of the set of durations; and
in response to determining the first subset of durations is not valid for the third control signaling, terminate monitoring the set of PDCCH candidates associated with the PDCCH during a second time duration associated with the default subset of durations based at least in part on the received third control signaling.

7. The UE of claim 1, wherein the at least one processor is further configured cause the UE to determine to terminate monitoring the set of PDCCH candidates associated with the PDCCH during the first time duration associated with the first subset of durations based at least in part on the received third control signaling, and traffic jitter statistics or a set of traffic jitter values.

8. The UE of claim 7, wherein the at least one processor is further configured to cause the UE:
receive, from the base station, a fourth control signaling; and
determine the traffic jitter statistics or the set of traffic jitter values based at least in part on the received fourth control signaling.

9. The UE of claim 1, wherein the at least one processor is further configured to cause the UE:
receive a configuration for a first search space set within the set of PDCCH candidates;
receive a medium access control-control element (MAC-CE) indicating to not skip the first search space set upon reception of the third control signaling, the MAC-CE further including a search space set identifier (ID) corresponding to the first search space set; and
exclude a time associated with the first search space set from the first time duration.

10. A base station for wireless communication, comprising:
at least one memory; and
at least one processor coupled with the at least one memory and configured to cause the base station to:
transmit, to a user equipment (UE), first control signaling indicating a set of skipping durations associated with skipping of monitoring for a physical downlink control channel (PDCCH);
transmit, to the UE, second control signaling indicating to activate a first subset of durations of the set of durations;
transmit, to the UE, third control signaling indicating for the UE to terminate monitoring a set of PDCCH candidates associated with the PDCCH, according to a set of downlink control information (DCI) formats for a serving cell, during a first time duration associated with the first subset of durations; and
terminate transmitting DCI messages to the UE during the first time duration associated with the first subset of durations.

11. The base station of claim 10, wherein the second control signaling is a medium access control-control element (MAC-CE).

12. (canceled)

13. The base station of claim 10, wherein the at least one processor is further configured to cause the base station to:
transmit, to the UE, a fourth control signaling indicating a configuration for a first search space set within the set of PDCCH candidates;
transmit, to the UE, a medium access control-control element (MAC-CE) indicating to not skip the first search space set upon reception of the third control signaling, the MAC-CE further including a search space set identifier (ID) corresponding to the first search space set; and
exclude a time associated with the first search space set from the first time duration.

14. A method performed by a user equipment (UE), the method comprising:
receiving, from a base station, first control signaling indicating a set of durations associated with skipping monitoring for a physical downlink control channel (PDCCH);
receiving, from the base station, second control signaling indicating to activate a first subset of durations of the set of durations;
receiving, from the base station, third control signaling indicating for the UE to terminate monitoring a set of PDCCH candidates associated with the PDCCH, according to a set of downlink control information (DCI) formats for a serving cell, during a first time duration associated with the first subset of durations; and
terminate monitoring the set of PDCCH candidates associated with the PDCCH during the first time duration associated with the first subset of durations based at least in part on the received third control signaling.

15. (canceled)

16. (canceled)

17. (canceled)

18. (canceled)

19. The method of claim 14, further comprising determining to terminate monitoring the set of PDCCH candidates associated with the PDCCH during the first time duration associated with the first subset of durations based at least in part on the received third control signaling, and traffic jitter statistics or a set of traffic jitter values.

20. The method of claim 14, further comprising:
receiving a configuration for a first search space set within the set of PDCCH candidates;
receiving a medium access control-control element (MAC-CE) indicating to not skip the first search space set upon reception of the third control signaling, the MAC-CE further including a search space set identifier (ID) corresponding to the first search space set; and
excluding a time associated with the first search space set from the first time duration.

21. A processor for wireless communication, comprising:
at least one controller coupled with at least one memory and configured to cause the processor to:
receive, from a base station, first control signaling indicating a set of durations associated with skipping of monitoring for a physical downlink control channel (PDCCH);
receive, from the base station, second control signaling indicating to activate a first subset of durations of the set of durations;
receive, from the base station, third control signaling indicating for the processor to terminate monitoring a set of PDCCH candidates associated with the PDCCH, according to a set of downlink control information (DCI) formats for a serving cell, during a first time duration associated with the first subset of durations; and
terminate monitoring the set of PDCCH candidates associated with the PDCCH during the first time duration associated with the first subset of durations based at least in part on the received third control signaling.

22. The processor of claim 21, wherein the second control signaling is a medium access control-control element (MAC-CE).

23. The processor of claim 22, wherein the MAC-CE is scheduled via the PDCCH.

24. The processor of claim 21, wherein the at least one controller is further configured to cause the processor to:
determine whether the first subset of durations is valid for the third control signaling; and
in response to determining the first subset of durations is valid, terminate monitoring the set of PDCCH candidates during the first time duration.

25. The processor of claim 24, wherein the second control signaling is a medium access control-control element (MAC-CE), and wherein, to determine whether the first subset of durations is valid for the third control signaling, the at least one controller is further configured to cause the processor to determine that the first subset of durations is valid if a positive acknowledgment is generated in response to the MAC-CE and the positive acknowledgment is not sent to the base station earlier than a threshold time.
